(19) United States
(12) Patent Application Publication
(10) Pub. No.: US 2017/0107965 A1
(43) Pub. Date: Apr. 20, 2017

(54) Delayed Ignition Control Device

(71) Applicant: Yuyao Aoxin Electrical Appliance Co., Ltd., Yuyao, Zhejiang (CN)

(72) Inventor: Jiaohong Ni, Yuyao, Zhejiang (CN)

(21) Appl. No.: 15/039,871

(22) PCT Filed: Nov. 18, 2015
(86) PCT No.: PCT/CN15/94863

§ 371 Date: May 27, 2016

(30) Foreign Application Priority Data
Apr. 20, 2015 (CN) 201510188234.8

(51) Int. Cl. F02P 5/00; F02P 3/06

(52) U.S. Cl. CPC F02P 5/00; F02P 3/06

(57) ABSTRACT

A delayed ignition control device comprises a charging circuit and a delayed ignition control circuit. In the delayed ignition control circuit, the resistor R6 is connected between the positive electrode of the input end of the photo coupling IC and the initial end of the power coil N3; the shut-off switch S1 is connected between the negative electrode of the input terminal of the photo coupling IC and the ground; the collector electrode of the photo coupling IC is connected with the initial end of the power coil N3; the output end of the photo coupling IC is connected with the anode of the diode D5; the voltage holding capacitor C2 is connected between the negative electrode of the diode D5 and the ground; and the resistor R8 is connected with the negative electrode of the diode D5 and the controller electrode of the silicon controlled SCR2.

### BACKGROUND OF THE INVENTION

Technical Field

The present invention relates to ignition devices, in particular to an ignition control device with a delayed ignition function.

Description of Related Art

Existing forestry tools such as chainsaws usually use general small gasoline engines as power sources. To stop the engine usually requires the user pressing a button to cut off the current in the power coil of the magnetic motor type ignition control device, which directly short circuits the power coils such that the power coil stops working. However, once the button is released, the ignition recovers, and the engine continues to rotate. Chainsaws are usually manually held while in operation. During lumbering, if an operator presses the shut-off switch and then releases it, the engine will stop for a while and then immediately start to rotate again. Having the tool resart in such a sudden fashion could result in damage to the chainsaws themselves and also endanger the physical safety of the operator. Such a shut-off mode poses potentially huge safety implications in actual use. To solve the above problems, it is required that, after the operator presses the shut-off button, the engine cannot ignite and rotate before it becomes completely motionless, and the engine can only begin to rotate again after the engine is manually started, thus preventing damage to the chainsaw and personal injury.

When the rotation speed of the general small gasoline engine exceeds the maximum power point of the engine, the power is reduced, increasing energy consumption. Excessive rotation speed can shorten the mechanical service life of the engine. The rotation speed of the general small gasoline engines usually increase suddenly to make the engines gallop, which endangers the safety of the operator. Limiting the maximum rotation speed of the engine is a good method for saving energy, prolonging the service life of the engines and preventing operators from personal injuries.

### BRIEF SUMMARY OF THE INVENTION

To solve the above problems, the present invention provides a delayed ignition control device, including:

A charging circuit 1, wherein the charging circuit 1 including a power coil N3, an energy-saving capacitor C1 and a diode D1, wherein an anode of the diode D1 is connected to an initial end of the power coil N3, a cathode of the diode D1 is connected to the energy-saving capacitor C1; the other end of the energy-saving capacitor C1 is connected to an ignition coil; and,

A delayed ignition control circuit 3, the delayed ignition control circuit 3 including a silicon controlled SCR2, a photo coupling IC, a diode D5, a voltage holding capacitor C2, a shut-off switch S1, a resistor R6 and a resistor R8; wherein, the resistor R6 is connected between the positive electrode of the input end of the photo coupling IC and the initial end of the power coil N3; the shut-off switch S1 is connected between the negative electrode of the input terminal of the photo coupling IC and the ground; the collector electrode of the photo coupling IC is connected with the initial end of the power coil N3; the output end of the photo coupling IC is connected with the anode of the diode D5; the voltage holding capacitor C2 is connected between the negative electrode of the diode D5 and the ground; and the resistor R8 is connected with the negative electrode of the diode D5 and the controller electrode of the silicon controlled SCR2.

Furthermore, the charging circuit 1 also comprises a diode D3 and a voltage-regulator tube D4, wherein the cathode of the diode D3 is connected to the tail end of the power coil N3; the anode of the diode D3 is connected to the positive electrode of the voltage-regulator tube D4, and the negative electrode of the voltage-regulator tube D4 is connected to the other end of the ignition coil and is grounded.

Furthermore, the delayed ignition control device also includes an ignition time control circuit 2 for controlling the ignition time of the ignition coil, wherein the ignition time control circuit 2 includes a silicon controlled SCR1 and a silicon controlled SCR3; the cathode of the silicon controlled SCR1 is grounded; the anode of the silicon controlled SCR1 is connected with the cathode of the diode D1; the controller electrode of the silicon controlled SCR1 is grounded through the resistor R9 and the capacitor C3; the cathode of the silicon controlled SCR3 is grounded; the anode of the silicon controlled SCR3 is connected to the tail end of the power coil N3 through the resistor R2; the anode of the silicon controlled SCR3 is connected to the controller electrode of the silicon controlled SCR1 through resistors R3 and R5, which are connected in series; and the controller electrode of the silicon controlled SCR3 is connected to the initial end of the power coil N3 through the resistor R1.

Furthermore, the ignition time control circuit 2 also includes a resistor R4, a resistor R7 and a voltage-regulator tube D6; the resistor R4 is connected between the resistor R3 and the ground; the negative electrode of the voltage-regulator tube D6 is connected to the controller electrode of the silicon controlled SCR1, while the positive electrode is grounded through the resistor R7; the connection point between the voltage-regulator tube D6 and the resistor R7 is connected with the connection point between the diode D3 and the voltage-regulator tube D4.

Furthermore,the delayed ignition control device also comprises a CDI assembly (4), a high-voltage output needle (8), an epoxy resin (9), a shell (10) and an iron core (11).

The present invention provides another delayed ignition control device, including:

A charging circuit 1, wherein the charging circuit 1 including a power coil N3, an energy-saving capacitor C1 and a diode D1, wherein an anode of the diode D1 is connected to an initial end of the power coil N3, a cathode of the diode D1 is connected to the energy-saving capacitor C1; the other end of the energy-saving capacitor is connected to an ignition coil; and,

A delayed ignition control circuit 3, the delayed ignition control circuit 3 including a silicon controlled SCR2, a diode D5, a diode D7, a voltage holding capacitor C2, a shut-off switch S1, a resistor R6 and a resistor R8, wherein, the resistor R6 is connected between the initial end of the power coil N3 and the anode of the diode D5; the cathode of the diode D5 is connected with the resistor R8 through the capacitor C2; the other end of the resistor R8 is connected with the controller electrode of the silicon controlled SCR2; the other end of the voltage holding capacitor C2 is connected with one end of the shut-off switch S1 and the cathode of the diode D7, and the other end of the Si and the anode of the diode D7 are grounded.

The present invention has the advantages of simple structure, easy adjustment of the delay time, and reliable operation.

### BRIEF DESCRIPTION OF THE SEVERAL VIEWS OF THE DRAWINGS

FIG. 1 is a circuit diagram of the first embodiment of the present invention.

FIG. 2 is a circuit diagram of the second embodiment of the present invention.

FIG. 3 is a main structural view of the present invention in the assembled status.

FIG. 4 is a right view of the structure as shown in FIG. 3.

### DETAILED DESCRIPTION OF THE INVENTION

The present invention is described below with reference to the attached drawings. Wherein, similar parts are represented by the same marks in the attached drawings.

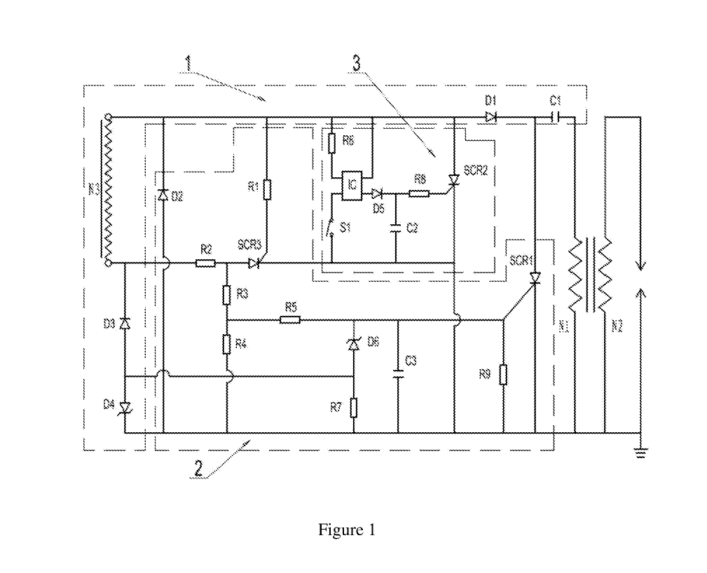

FIG. 1 displays the circuit diagram of the first embodiment of the present invention. The delayed ignition control device of the present invention includes a charging circuit 1, an ignition time control circuit 2 and a delayed ignition control circuit 3.

The charging circuit 1 includes a power coil N3, an energy-saving capacitor C1, a diode D1, a diode D1, a diode D3 and a voltage-regulator tube D4. The power coil N3 is connected to an external power supply; the anode of the diode D1 is connected to the initial end of the power coil N3, and the cathode is connected to the energy-saving capacitor Cl. The other end of the energy-saving capacitor C1 is connected to one end of the ignition coil N1, and the other end of the power coil N3 is connected to the other end of the ignition coil N1 and is grounded. The cathode of the diode D3 is connected to the tail end of the power coil N3; the anode of the diode D3 is connected to the positive electrode of the voltage-regulator tube D4, and the negative electrode of the voltage-regulator tube D4 is connected to the other end of the ignition coil and is grounded. The ignition coil can include a primary winding N1 and a secondary winding N2; the energy-saving capacitor C1 provides the ignition coil with voltage and power generates high-voltage discharge and therefore breaks down the electrode of the spark plug such that the engine ignites.

The function of the charging circuit 1 is to charge the energy-saving capacitor C1. Specifically speaking, when the gasoline engine rotates, the power coil N3 cuts the magnetic lines, and the magnetic induction pulse on the power coil N3 passes through a circuit consisting of the power coil N3, the diode D1, the energy-saving capacitor C1 and the primary winding N1 of the ignition coil to charge the energy-saving capacitor C1.

Further refer to FIG. 1. The ignition time control circuit 2 includes a silicon controlled SCR1. The cathode (K) of the silicon controlled SCR1 is grounded;

The anode (A) of the silicon controlled SCR1 is connected to the cathode of the diode D1; the controller electrode (G) of the silicon controlled SCR1 is connected with the resistor R9, the capacitor C3, the voltage-regulator tube D6 and the resistor R5. The other ends of the capacitor R9 and the capacitor 3 are grounded. The negative electrode of the voltage-regulator tube D6 is connected with the controller electrode (G) of the silicon controlled SCR1. The ignition time control circuit 2 is used for controlling the energy conservation and release of the energy-saving capacitor C1 of the charging circuit 1, realizing the ignition at a specific time through the on-off of the silicon controlled SCR1. The ignition time control circuit 2 also includes a silicon controlled SCR3; the cathode (K) of the silicon controlled SCR3 is grounded; the anode (A) of the silicon controlled SCR3 is connected to the tail end of the power coil N3 through the resistor R2; and the anode (A) of the silicon controlled SCR3 is connected to the controller electrode (G) of the silicon controlled SCR1 through resistors R3 and R5 which are connected in series. The controller electrode (G) of the silicon controlled SCR3 is connected to the initial end of the power coil N3 through the resistor R1.

The ignition time control circuit 2 also includes a diode D2; the anode of the diode D2 is grounded, while the cathode is connected to the initial end of the power coil N3.

The ignition time control circuit 2 also includes resistors R4 and R7. The resistor R4 is connected between the resistor R3 and the ground. The resistor R7 is connected with the voltage-regulator tube D6 and the ground. Meanwhile, the connection point between the voltage-regulator tube D6 and the resistor R7 and the connection point between the diode D3 and the voltage-regulator D4 are connected together.

When the engine is started, the triggering time of the silicon controlled SCR1 is controlled through the silicon controlled SCR3, the resistors R1, R2, R3, R5, R7 and R9, the diode D2, the capacitor C3 and the voltage-regulator tube D6, thus control the discharge of the energy-saving capacitor C1.

Refer to FIG. 1. The delayed ignition control circuit 3 includes a silicon controlled SCR2, a photo coupling IC, a diode D5, a voltage holding capacitor C2, a shut-off switch S1, a resistor R6 and a resistor R8.

Resistor R6 is connected between the positive electrode of the input end of the photo coupling IC and the initial end of the power coil N3; the shut-off switch S1 is connected between the negative electrode of the input terminal of the photo coupling IC and the ground; the collector electrode of the photo coupling IC is connected with the initial end of the power coil N3; the output end of the photo coupling IC is connected with the anode of the diode D5; the voltage holding capacitor C2 is connected between the negative electrode of the diode D5 and the ground; and the resistor R8 is connected with the negative electrode of the diode D5 and the controller electrode of the silicon controlled SCR2.

The function of the delayed ignition control circuit 3 is as follows. After the stop switch is pressed down and before the engine completely stops rotating, the energy-saving capacitor C1 cannot be re-charged, thus ensuring that the magnetic motor cannot ignite before the engine completely stops rotating. The engine then stops safely.

The working principle of the first embodiment is as follows:

Specifically speaking, when the gasoline engine rotates, the power coil N3 cuts the magnetic lines, and the magnetic induction pulse on the power coil N3 passes through a circuit consisting of the power coil N3, the diode D1, the energy-saving capacitor C1 and the primary winding N1 of the ignition coil to charge the energy-saving capacitor C1. The negative half-wave of the magnetic induction pulse on the power coil N3 passes through the circuit consisting of the power coil N3, the resistors R2, R3 and R5, the silicon controlled SCR1 and the diode D2 to trigger the silicon controlled SCR1 such that the energy-saving capacitor C1 can perform instant discharge through the silicon controlled SCR1 and the primary coil N1; the secondary coil N2 generates a high voltage to break down the spark plug to discharge and ignite the compressed fuel gas in the engine cylinder, and then the engine works.

When the shut-off switch S1 is switched on, the magnetic induction pulse generated on the power coil N3 passes through the circuit consisting of the power coil N3, the resistor R6, the photo coupling IC and the shut-off switch S1, and the output electrode of the photo coupling IC is switched on at the same time to charge the capacitor C2 through the diode D5, while the energy-saving capacitor C1 cannot be charged to save energy, so the engine does not ignite.

When the shut-off switch S1 is switched off, the voltage holding capacitor C2 continuously supplies power to the triggering electrode of the silicon controlled SCR2 to maintain the silicon controlled switch SCR2 in the on status. Meanwhile, the magnetic conduction pulse on the power coil N3 is generated again and passes through the circuit consisting of the power coil N3, the silicon controlled SCR2 and the resistors R2, R3 and R4, and the energy-saving capacitor C1 cannot save energy, so the engine does not ignite. After the voltage holding capacitor C2 completes discharging, the engine can ignite normally, thus realizing the function of delayed ignition.

The duration of the delayed ignition status can be achieved by adjusting the parameters of the two elements, namely the voltage holding capacitor C2 and the resistor, R8.

Which controls the amount of time it takes for the engine to transition first from a start to a stop mode, and then for the engine to become completely motionless, thus ensuring a safe stoppage of the engine.

In conclusion, the magnetic motor type ignition control device with the delayed ignition function for safe stoppage has the following advantages: simple structure, easy adjustment and reliable operation.

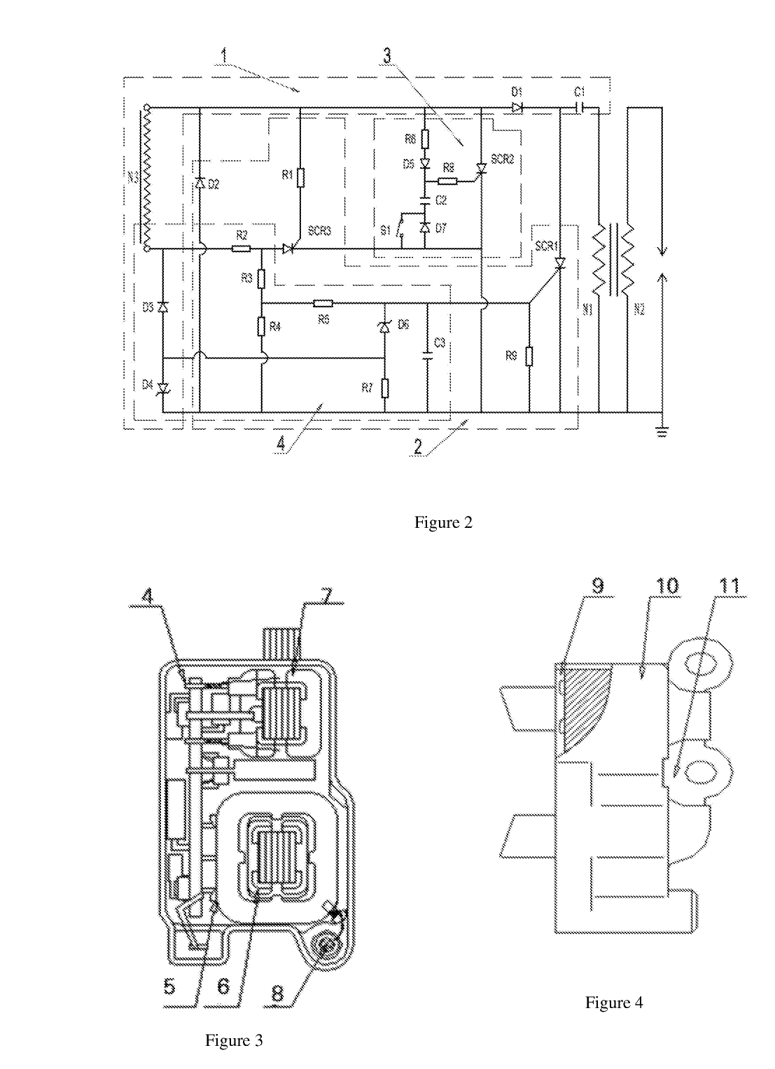

FIG. 2 displays the circuit diagram of the second embodiment of the present invention, wherein the charging circuit 1 and the ignition time control circuit 2 are identical with those in the first embodiment and therefore are not described repeatedly here.

The difference is in the delayed ignition control circuit 3 and a speed-limiting control circuit 4.

The delayed ignition control circuit 3 is used to control the energy saving time of the energy-saving capacitor C1. The delayed ignition control circuit 3 includes resistors R6 and R8, the silicon controlled SCR2, diodes D5 and D7, a voltage holding capacitor C2 and a shut-off switch S1. The resistor R6 is connected between the power coil N3 and the anode of the diode D5; the cathode of the diode D5 is connected with the resistor R8 through the capacitor C2; the other end of the resistor R8 is connected with the controller electrode of the silicon controlled SCR2; the other end of the voltage holding capacitor C2 is connected with one end of the shut-off switch S1 and the cathode of the diode D7, and the other end of the S1 and the anode of the diode D7 are grounded. The speed-limiting control circuit 4 actually is comprised of a part of each of the charging circuit 1 and the ignition time control circuit 2. Specifically, the speed-limiting control circuit 4 consists of resistors R2, R3, R4, R5 and R7, the diode D3, the voltage-regulator tubes D4 and D6 and the capacitor C3. The cathodes of the resistor R2 and diode D3 are connected with the tail end of the power coil N3; the anode of the diode D3 is connected with the anodes of the voltage-regulator tubes D4 and D6 and one end of the resistor R7; the other end of the resistor R2 is connected with one end of each of the silicon controlled SCR3 and the resistor R3; one end of the resistor R3 is connected with one end of each of the resistors R4 and R5; the other end of the resistor R5 is connected with the cathode of D6 and one end of the capacitor C3 as well as the controller electrode of the silicon controlled SCR1; and the cathode of the D4 and the other ends of the resistors R4, R7 and the capacitor C3 are grounded.

The working principle of the second embodiment is as follows:

Specifically speaking, when the gasoline engine rotates, the power coil N3 cuts the magnetic lines, and the magnetic induction pulse on the power coil N3 passes through a circuit consisting of the power coil N3, the diode D1, the energy-saving capacitor C1 and the primary winding N1 of the ignition coil to charge the energy-saving capacitor C1. The negative half-wave of the magnetic induction pulse on the power coil N3 passes through the circuit consisting of the power coil N3, the resistors R2, R3 and R5, the silicon controlled SCR1 and the diode D2 to trigger the silicon controlled SCR1 such that the energy-saving capacitor C1 can perform instant discharge through the silicon controlled SCR1 and the primary coil N1; the secondary coil N2 generates a high voltage to break down the spark plug to discharge and ignite the compressed fuel gas in the engine cylinder, and then the engine works.

When the shut-off switch S1 is switched on, the magnetic induction pulse generated on the power coil N3 passes through the circuit consisting of the power coil N3, the resistor R6, the diode D5, the voltage holding capacitor C2 and the shut-off switch S1 to charge the voltage holding capacitor C2 through the resistor R6 and the diode D5, and the energy-saving capacitor C1 cannot be charged to save energy, so the engine does not ignite.

When the shut-off switch S1 is switched off, the voltage holding capacitor C2 continuously supplies power to the triggering electrode of the silicon controlled SCR2 to maintain the silicon controlled switch SCR2 in the on status. Meanwhile, the magnetic conduction pulse on the power coil N3 is generated again and passes through the circuit consisting of the power coil N3, the silicon controlled SCR2 and the resistors R2, R3 and R4, and the energy-saving capacitor C1 cannot save energy, so the engine does not ignite. After the voltage holding capacitor C2 completes discharging, the engine can ignite normally, thus realizing the function of delayed ignition.

The duration of the delayed ignition status can be achieved by adjusting the parameters of the two elements, namely C2 and R8, to ensure that the amount of time it takes for the engine to transition first from a start to a stop mode, and then for the engine to become completely motionless, thus ensuring a safe stoppage of the engine.

Working principle of the speed-limiting function: the magnetic induction pulse generated on the power coil N3 passes through the circuit consisting of the power coil N3, the resistors R2, R3 and R5, the capacitor C3 and the diode D2 to charge the capacitor C3; the SCR1 is not triggered; the capacitor C3 discharges to the silicon controlled SCR1 after being fully charged such that the silicon controlled SCR1 is triggered and switched on. By adjusting the parameters of the diodes D4 and D6, the triggering and switch-on time of the silicon controlled SCR1 is controlled, thus changing the ignition angle of the engine to limit the maximum rotation speed of the engine, realizing the speed-limiting function of the engine.

FIG. 3 is a main structural view of the present invention in the assembled status. FIG. 4 is a right view of the structure as shown in FIG. 3. The delayed ignition control device also comprises a CDI assembly 4 (Capacitor Discharge Igniter), a high-voltage output needle (8), an epoxy resin (9), a shell (10) and a iron core (11). The iron core (11) is disposed on the housing (10), and integrated with the shell through injection molding (see mark 11 in FIG. 4). The high-voltage output needle 8 is pressed into a high-voltage needle hole on the shell 10 (see mark 8 in FIG. 3). The epoxy resin 9 is encapsulated in the shell 10. The CDI assembly 4 consists of the charging circuit 1, the ignition angle control circuit 2, the delayed ignition control circuit 3 and the limit speed control circuit 4. The figure also displays the locations of the second winding 5, primary winding 6 and power coil 7.

The above embodiments are only preferable embodiments of the present invention. Changes and substitutions made by those skilled in this field on the basis of the technical solution of the present invention shall fall within the protective scope of the present invention.

What is claimed is:

1. A delayed ignition control device, characterized by comprising:
a charging circuit (1), the charging circuit (1) comprising a power coil N3, an energy-saving capacitor C1 and a diode D1; an anode of the diode D1 being connected to an initial end of the power coil N3, a cathode of the diode D1 being connected to the energy-saving capacitor C1; the other end of the energy-saving capacitor being connected to an ignition coil;
a delayed ignition control circuit (3), the delayed ignition control circuit (3) comprising a silicon controlled SCR2, a photo coupling IC, a diode D5, a voltage holding capacitor C2, a shut-off switch S1, a resistor R6 and a resistor R8; wherein, the resistor R6 is connected between the positive electrode of the input end of the photo coupling IC and the initial end of the power coil N3; the shut-off switch S1 is connected between the negative electrode of the input terminal of the photo coupling IC and the ground; the collector electrode of the photo coupling IC is connected with the initial end of the power coil N3; the output end of the photo coupling IC is connected with the anode of the diode D5; the voltage holding capacitor C2 is connected between the negative electrode of the diode D5 and the ground; and the resistor R8 is connected with the negative electrode of the diode D5 and the controller electrode of the silicon controlled SCR2.

2. The delayed ignition control device according to claim 1, characterized in that, the charging circuit (1) also comprises a diode D3 and a voltage-regulator tube D4, wherein the cathode of the diode D3 is connected to the tail end of the power coil N3; the anode of the diode D3 is connected to the positive electrode of the voltage-regulator tube D4, and the negative electrode of the voltage-regulator tube D4 is connected to the other end of the ignition coil and is grounded.

3. The delayed ignition control device according to claim 2, characterized by also comprising an ignition time control circuit (2) for controlling the ignition time of the ignition coil, wherein the ignition time control circuit (2) comprises a silicon controlled SCR1 and a silicon controlled SCR3;
the cathode of the silicon controlled SCR1 is grounded; the anode of the silicon controlled SCR1 is connected to the cathode of the diode D1; the controller electrode of the silicon controlled SCR1 is grounded through the resistor R9 and the capacitor C3;
the cathode of the silicon controlled SCR3 is grounded; the anode of the silicon controlled SCR3 is connected to the tail end of the power coil N3 through the resistor R2; the anode of the silicon controlled SCR3 is connected to the controller electrode of the silicon controlled SCR1 through resistors R3 and R5, which are connected in series; and the controller electrode of the silicon controlled SCR3 is connected to the initial end of the power coil N3 through the resistor R1.

4. The delayed ignition control device according to claim 3, characterized in that, the ignition time control circuit (2) also comprises a resistor R4, a resistor R7 and a voltage-regulator tube D6; the resistor R4 is connected between the resistor R3 and the ground; the negative electrode of the voltage-regulator tube D6 is connected to the controller electrode of the silicon controlled SCR1, while the positive electrode is grounded through the resistor R7; the connection point between the voltage-regulator tube D6 and the resistor R7 is connected with the connection point between the diode D3 and the voltage-regulator tube D4.

5. The delayed ignition control device according to claim 1, characterized in that, the delayed ignition control device also comprises a CDI assembly (4), a high-voltage output needle (8), an epoxy resin (9), a shell (10) and an iron core (11).

6. A delayed ignition control device, characterized by comprising:
a charging circuit (1), the charging circuit (1) comprising a power coil N3, an energy-saving capacitor C1 and a diode D1; an anode of the diode D1 being connected to an initial end of the power coil N3, a cathode of the diode D1 being connected to the energy-saving capacitor C1; the other end of the energy-saving capacitor being connected to an ignition coil;
a delayed ignition control circuit (3), the delayed ignition control circuit (3) comprising a silicon controlled SCR2, a diode D5, a diode D7, a voltage holding capacitor C2, a shut-off switch S1, a resistor R6 and a resistor R8, wherein, the resistor R6 is connected between the initial end of the power coil N3 and the anode of the diode D5; the cathode of the diode D5 is connected with the resistor R8 through the capacitor C2; the other end of the resistor R8 is connected with the controller electrode of the silicon controlled SCR2; the other end of the voltage holding capacitor C2 is connected with one end of the shut-off switch S1 and the cathode of the diode D7, and the other end of the S1 and the anode of the diode D7 are grounded.

7. The delayed ignition control device according to claim 6, characterized in that, the charging circuit (1) also comprises a diode D3 and a voltage-regulator tube D4, wherein the cathode of the diode D3 is connected to the tail end of the power coil N3; the anode of the diode D3 is connected to the positive electrode of the voltage-regulator tube D4, and the negative electrode of the voltage-regulator tube D4 is connected to the other end of the ignition coil and is grounded.

8. The delayed ignition control device according to claim 7, characterized by also comprising an ignition time control circuit (2) for controlling the ignition time of the ignition coil, wherein the ignition time control circuit (2) comprises a silicon controlled SCR1 and a silicon controlled SCR3;
the cathode of the silicon controlled SCR1 is grounded; the anode of the silicon controlled SCR1 is connected to the cathode of the diode D1; the controller electrode of the silicon controlled SCR1 is grounded through the resistor R9 and the capacitor C3;
the cathode of the silicon controlled SCR3 is grounded; the anode of the silicon controlled SCR3 is connected to the tail end of the power coil N3 through the resistor R2;
the anode of the silicon controlled SCR3 is connected to the controller electrode of the silicon controlled SCR1 through resistors R3 and R5 which are connected in series; and
the controller electrode of the silicon controlled SCR3 is connected to the initial end of the power coil N3 through the resistor R1.

9. The delayed ignition control device according to claim 8, characterized in that, the ignition time control circuit (2) also comprises a resistor R4, a resistor R7 and a voltage-regulator tube D6; the resistor R4 is connected between the resistor R3 and the ground; the negative electrode of the voltage-regulator tube D6 is connected to the controller electrode of the silicon controlled SCR1, while the positive electrode is grounded through the resistor R7; the connection point between the voltage-regulator tube D6 and the resistor R7 is connected with the connection point between the diode D4 and the voltage-regulator tube D4.

10. The delayed ignition control device according to claim 5, characterized in that, the delayed ignition control device also comprises a CDI assembly (4), a high-voltage output needle (8), an epoxy resin (9), a shell (10) and an iron core (11).
